(19) United States
(12) Patent Application Publication
(10) Pub. No.: US 2012/0293628 A1
(43) Pub. Date: Nov. 22, 2012

(54) CAMERA INSTALLATION POSITION EVALUATING METHOD AND SYSTEM

(75) Inventors: Masayoshi Hashima, Kawasaki (JP); Shinichi Sazawa, Atsugi (JP); Hiroki Kobayashi, Kawasaki (JP)

(73) Assignee: FUJITSU LIMITED, Kawasaki-shi (JP)

(21) Appl. No.: 13/562,715

(22) Filed: Jul. 31, 2012

Related U.S. Application Data
(63) Continuation of application No. PCT/JP2010/051450, filed on Feb. 2, 2010.

(51) Int. Cl. H04N 17/00

(52) U.S. Cl. 348/46; 348/E17.002

(57) ABSTRACT

A camera installation position evaluating system includes a processor, the processor executing a process including setting a virtual plane orthogonal to the optic axis of a camera mounted on a camera mounted object, generating virtually a camera image to be captured by the camera, with use of data about a three-dimensional model of the camera mounted object, data about the virtual plane set by the setting and parameters of the camera, and computing a boundary between an area of the three-dimensional model of the camera mounted object and an area of the virtual plane set by the setting, on the camera image generated by the generating. Accordingly, the camera installation position evaluating system is able to quantitatively obtain the camera's view range at the present camera installation position based on the computed boundary.

### CROSS-REFERENCE TO RELATED APPLICATION

This application is a continuation application of International Application PCT/JP2010/051450 filed on Feb. 2, 2010 and designated the U.S., the entire contents of which are incorporated herein by reference.

### FIELD

The present invention relates to a camera installation position evaluating program, camera installation position evaluating method and camera installation position evaluating system.

### BACKGROUND

Conventionally, various proposals have been made on a technique for determining an installation position of a camera to be incorporated into a device, structural object, movable object or the like. Examples of such cameras are an environmental measurement camera to be mounted on a robot or the like, and a surveillance camera for use in a building.

When a camera is embedded and installed in a device or structural object, the camera is desirably deeply embedded in the device or structural object so that the camera is hidden. However, when the camera is deeply embedded in the device or structural object, a part of the device or structural object may be caught, as an obstruction, in the camera's view range. In determining the installation position of the camera, an area in the camera's view range catching the device or structural object is preferably made as small as possible. Accordingly, in determining the installation position of the camera, for instance, a conventional art 1 that conducts a simulation with use of a camera image or a conventional art 2 that generates a three-dimensional model which expresses the camera's view range has been employed.

To determine the installation position of the camera with use of the above-described conventional art 1, a designer of the camera installation position designates the installation position of the camera within a three-dimensional model of the device or structural object into which the camera is to be embedded, at first. According to the conventional art 1, on the assumption that the camera is installed at a position designated by the designer within the three-dimensional model, a virtual image to be captured by the camera is generated with the camera's characteristics (e.g., field angle, lens distortion) taken into consideration. The conventional art 1 then outputs and displays the generated virtual image. The designer observes the outputted and displayed image, confirms the camera's view range and the area in the view range catching the device or structural object in which the camera is to be installed, and adjusts the installation position of the camera. In this manner, the installation position of the camera is determined. Examples of techniques for generating the virtual camera image are three-dimensional computer aided design (three-dimensional CAD) systems, digital mock-up, computer graphics and virtual reality.

On the other hand, when the installation position of the camera is determined with use of the above-described conventional art 2, a designer of the camera installation position designates the installation position of the camera within a three-dimensional model of the device or structural object into which the camera is to be embedded, at first. The conventional art 2, on the assumption that the camera is installed at a position designated by the designer within the three-dimensional model, generates a virtual view range model that represents the camera's view range corresponding to the installation position. The conventional art 2 then outputs and displays the generated view range model. The designer observes the outputted and displayed view range model, confirms blind areas that narrow the camera's view range, and adjusts the installation position of the camera. In this manner, the installation position of the camera is determined.

Patent Document 1: Japanese Laid-open Patent Publication No. 2009-105802

However, when the installation position of the camera is determined with use of the above-described conventional art 1, the designer observes the outputted and displayed image and judges whether or not the camera installation position is suitable, so as to determine the installation position of the camera. Likewise, when the installation position of the camera is designed with use of the conventional art 2, the designer observes the outputted and displayed view range model and judges whether or not the camera installation position is suitable, so as to determine the installation position of the camera. The conventional arts 1 and 2 have both been problematic, in that a designer's trial and error is required for designing the installation position of the camera.

In addition, when the installation position of the camera is determined with use of the above-described conventional art 2, the generated view range model includes blind areas. Thus, the conventional art 2 has been problematic, also in that it is difficult for the designer to recognize the camera's view range accurately.

### SUMMARY

According to an aspect of the embodiments, a computer-readable recording medium has stored therein a program for causing a computer to execute a process for evaluating a camera installation position, the process including setting a virtual plane orthogonal to an optic axis of a camera mounted on a camera mounted object; generating virtually a camera image to be captured by the camera, based on data about a three-dimensional model of the camera mounted object, data about the virtual plane that has been set and parameters of the camera; and computing a boundary between an area of the three-dimensional model and an area of the virtual plane, on the camera image that has been generated.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting a camera installation position evaluating system according to a first embodiment;

FIG. 2 is a diagram depicting a structure of a camera installation position evaluating system according to a second embodiment;

FIG. 3 is a perspective view of a model according to the second embodiment;

FIG. 4 is a side view of the model according to the second embodiment;

FIG. 5 is a view to be used for explaining a setting of a background plane according to the second embodiment;

FIG. 6 is a view depicting an example of the background plane according to the second embodiment;

FIG. 7 is a view depicting an example of a camera image according to the second embodiment;

FIG. 8 is a view to be used for explaining a first view range computing unit according to the second embodiment;

FIG. 9 is a view to be used for explaining the first view range computing unit according to the second embodiment;

FIG. 10 is a view to be used for explaining a view model generating unit according to the second embodiment;

FIG. 11 is a view to be used for explaining the view model generating unit according to the second embodiment;

FIG. 12 is a view to be used for explaining a second view range computing unit according to the second embodiment 2;

FIG. 13 is a flowchart of a processing of the camera installation position evaluating system according to the second embodiment;

FIG. 14 is a view to be used for explaining the processing of the camera installation position evaluating system according to the second embodiment;

FIG. 15 is a flowchart depicting the process of the camera installation position evaluating system according to the second embodiment; and

FIG. 16 is a view depicting an example of a computer that runs a camera installation position evaluating program.

### DESCRIPTION OF EMBODIMENTS

Preferred embodiments will be explained with reference to accompanying drawings. It should be noted that the present invention will not be limited by embodiments described later as an embodiment of the camera installation position evaluating program, camera installation position evaluating method and camera installation position evaluating system of the present invention.

### [a] First Embodiment

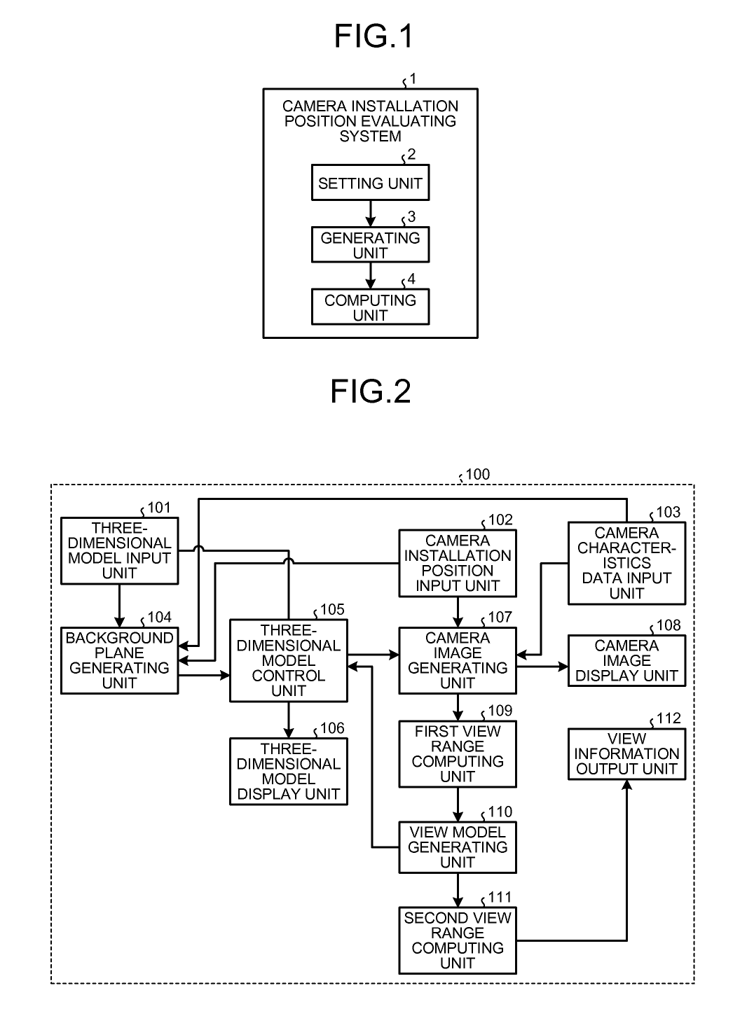

FIG. 1 is a diagram depicting a camera installation position evaluating system according to a first embodiment. As depicted in FIG. 1, a camera installation position evaluating system 1 includes a setting unit 2, a generating unit 3 and a computing unit 4.

The setting unit 2 sets a virtual plane orthogonal to the optic axis of a camera mounted on a camera mounted object. The virtual plane means a virtual plane orthogonal to the optic axis of the camera. The generating unit 3 generates a virtual camera image to be captured by the camera, with use of data about a three-dimensional model of the camera mounted object, data about the virtual plane set by the setting unit 2 and parameters of the camera. The computing unit 4 computes a boundary between the three-dimensional model of the camera mounted object and the virtual plane set by the setting unit 2 on the camera image generated by the generating unit 3.

The camera installation position evaluating system 1 sets, in the optic axis direction of the camera mounted on the camera mounted object, the virtual plane orthogonal to the optic axis, and subsequently generates the virtual camera image on the assumption that photographing is conducted with the camera. Therefore, the camera installation position evaluating system 1 can obtain data indicating how the camera mounted object is caught in the camera's view range. Further, the camera installation position evaluating system 1 computes the boundary between the three-dimensional model of the camera mounted object and the virtual plane set by the setting unit 2 on the virtual camera image, and thus is able to quantitatively obtain the camera's view range at the present camera installation position based on the computed boundary. Accordingly, in the camera installation position evaluating system 1 according to the first embodiment, a trial and error by a designer in determining the installation position of the camera is not required, and thus the installation position of the camera can be determined efficiently and accurately.

### [b] Second Embodiment

### Configuration of Camera Installation Position Evaluating System (Second Embodiment)

FIG. 2 is a diagram depicting a structure of a camera installation position evaluating system according to a second embodiment. As depicted in FIG. 2, a camera installation position evaluating system 100 according to the second embodiment includes a three-dimensional model input unit 101, a camera installation position input unit 102 and a camera characteristics data input unit 103.

As depicted in FIG. 2, the camera installation position evaluating system 100 further includes a background plane generating unit 104, a three-dimensional model control unit 105 and a three-dimensional model display unit 106. As in FIG. 2, the camera installation position evaluating system 100 also includes a camera image generating unit 107, a camera image display unit 108, a first view range computing unit 109, a view model generating unit 110, a second view range computing unit 111 and a view information output unit 112.

Note that, the background plane generating unit 104, the camera image generating unit 107, the camera image display unit 108, the first view range computing unit 109, the view model generating unit 110, the second view range computing unit 111 and the view information output unit 112 are, for instance, electronic circuits or integrated circuits. Examples of the electronic circuits are a central processing unit (CPU) and a micro processing unit (MPU), while examples of the integrated circuits are an application specific integrated circuit (ASIC) and a field programmable gate array (FPGA).

The three-dimensional model input unit 101 inputs the three-dimensional model of the camera mounted object. The three-dimensional model, which includes profile data, position data and color data, is expressed using a general-purpose format language such as a virtual reality modeling language (VRML). The camera mounted object means an object on which a camera is to be mounted, such as vehicles, structural objects (e.g., buildings) and robots. In addition, the three-dimensional model includes data about plane positions of a floor within the world coordinate system. The world coordinate system, which is a reference coordinate system based on which a position of an object within a three-dimensional space is defined, has: coordinate axes consisted of an X axis, Y axis and Z axis; and the origin. The X axis and the Y axis are coordinate axes that are orthogonal to each other on the floor. The Z axis is a coordinate axis that extends from an intersection of the X axis and the Y axis in the vertical direction to the floor.

The profile data includes the number of triangle polygons and coordinates of vertex positions within a model coordinate system of the triangle polygons. The above-described three-dimensional model of the camera mounted object is generated by combining a plurality of triangle polygons based on the coordinates of the each vertex positions.

The model coordinate system, which is a local coordinate system defined for each three-dimensional model, has the origin and three coordinate axes of an X axis, Y axis and Z axis that are orthogonal to one another. By defining, with reference to the world coordinate system, a position and an orientation of a three-dimensional model within the model coordinate system, the position and the orientation of the three-dimensional model in the three-dimensional space are determined.

The camera installation position input unit 102 inputs a plurality of samples as the candidates for the installation positions and orientations of the camera. The plurality of samples means, for instance, a combination of position vectors and rotation vectors prepared by changing a position and an orientation of a camera coordinate system. The camera coordinate system, which is a local coordinate system defined for each camera and whose origin is at the center of the lens of the camera, has: a Z axis extending in the direction of axis of the camera; an X axis passing through the origin and extending in parallel to a transverse axis of an imaging area; and a Y axis passing through the origin and extending orthogonal to the X-axis. The installation position of the camera is obtained by the position vector value of the origin of the camera coordinate system. In addition, the orientation of the camera is obtained by the rotation vector values of the X axis, Y axis and Z axis of the camera coordinate system. Examples of the rotation vector are roll angles, pitch angles, yaw angles and Euler angles. The roll angles are angles that represent horizontal inclination of the camera with respect to the camera mounted object. The pitch angles are angles that represent vertical inclination of the camera with respect to the camera mounted object. The yaw angles are, for instance, rotation angles of the camera with respect to the Z axis. The Euler angles are combinations of rotation angles of the each coordinate axes of the camera coordinate system.

The camera characteristics data input unit 103 inputs parameters necessary for generating a camera image such as field angles, focal lengths and imaging area sizes of the camera.

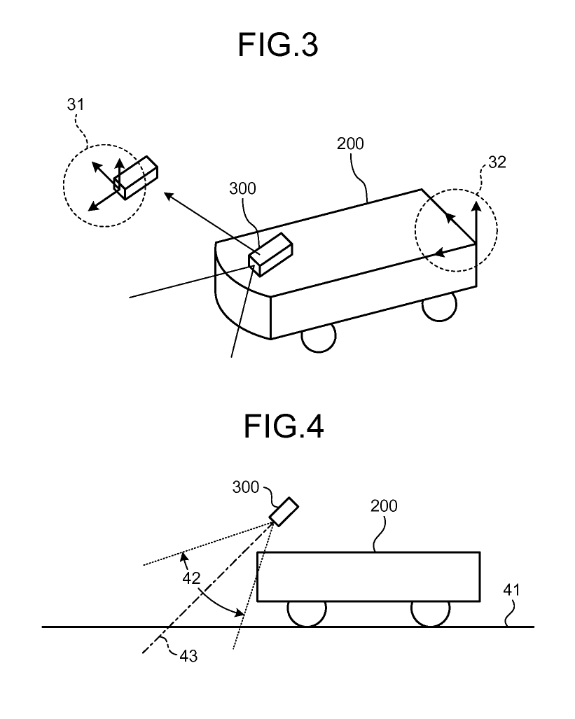

FIG. 3 is a perspective view of a model according to the second embodiment. FIG. 4 is a side view of the model according to the second embodiment. The reference sign 200 in FIG. 3 represents a three-dimensional model of the camera mounted object, and the reference sign 300 in FIG. 3 represents a model of a camera to be mounted on the camera mounted object. In addition, the reference sign 31 in FIG. 3 represents the camera coordinate system, and the reference sign 32 in FIG. 3 represents the model coordinate system. The reference sign 200 in FIG. 4 represents the three-dimensional model of the camera mounted object, and the reference sign 300 in FIG. 4 represents the model of the camera to be mounted on the camera mounted object. The reference sign 41 in FIG. 4 represents a floor on which the camera mounted object is located, the reference sign 42 in FIG. 4 represents the camera's view range, and the reference sign 43 represents the optic axis of the camera.

For instance, when the three-dimensional model input unit 101 inputs the three-dimensional model of the camera mounted object, the model coordinate system 32 as represented in FIG. 3 is dynamically defined with respect to the three-dimensional model. In addition, for instance, the camera installation position input unit 102 dynamically defines the camera coordinate system 31 for each of the plural samples inputted as the candidates for the installation positions and the orientations of the camera. Further, based on the field angles, focal lengths and imaging area sizes of the camera and the like inputted by the camera characteristics data input unit 103, data about the camera's view range 42 and the optic axis 43 of the camera as represented in FIG. 4 are obtained.

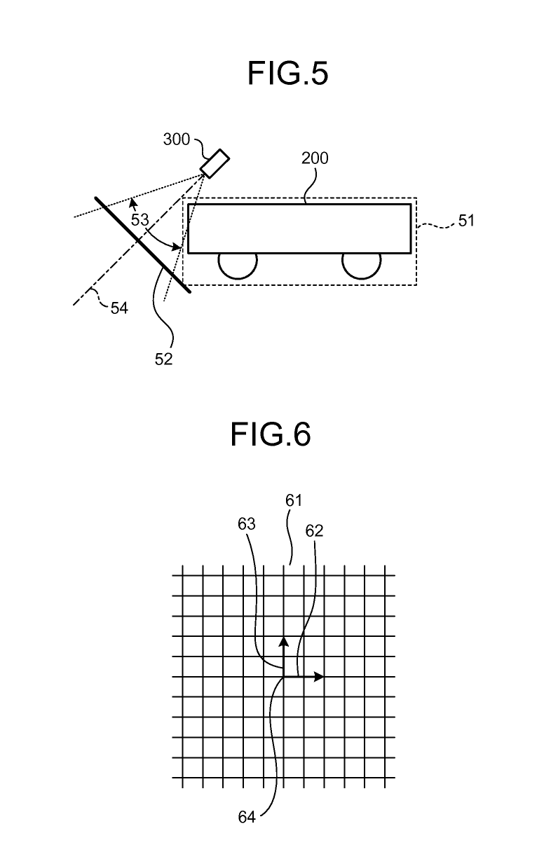

The background plane generating unit 104 sets a virtual background plane that is orthogonal to the optic axis of the camera to be mounted on the camera mounted object. FIG. 5 is a view to be used for explaining the setting of the background plane according to the second embodiment. FIG. 5 is a side view laterally depicting the three-dimensional model of the camera mounted object and the camera to be mounted on the object. The reference sign 200 in FIG. 5 represents the three-dimensional model of the camera mounted object, and the reference sign 300 in FIG. 5 represents the model of the camera. The reference sign 51 in FIG. 5 represents a bounding box, the reference sign 52 in FIG. 5 represents the background plane, the reference sign 53 in FIG. 5 represents the camera's view range and the reference sign 54 in FIG. 5 represents the optic axis of the camera. As represented by the reference sign 51 in FIG. 5, the bounding box is a rectangular region expressed as boundary segments that encompass the three-dimensional model.

As depicted in FIG. 5, for instance, the background plane generating unit 104, at first, computes the bounding box 51 of the three-dimensional model, based on data about the three-dimensional model of the camera mounted object inputted by the three-dimensional model input unit 101 as will be described later. The background plane generating unit 104 then computes the installation position and the optic axis of the camera, based on the data about the installation position of the camera inputted by the camera installation position input unit 102 and the data about the camera characteristics inputted by the camera characteristics data input unit 103. Subsequently, the background plane generating unit 104 computes planes that extend perpendicular to the optic axis 54 and pass through vertices of the bounding box 51, and sets as the background plane 52 a plane that is the remotest from an origination point of the optic axis 54 of the camera among the computed planes. The origination point of the optic axis 54 of the camera is, for instance, the center of the lens of the camera (i.e., so-called the optical center). The background plane 52 is not limited to a plane, but may be a sphericity when a camera having a fisheye lens is to be mounted on the camera mounted object. In addition, the background plane 52 is not limited to a plane that is orthogonal to the optic axis, but may be a background plane for which a local coordinate of a plane is defined.

FIG. 6 is a view depicting an example of the background plane according to the second embodiment. The reference sign 61 in FIG. 6 represents the background plane, the reference sign 62 in FIG. 6 represents an axis parallel to the X axis of the camera coordinate system, the reference sign 63 in FIG. 6 represents an axis parallel to the Y axis of the camera coordinate system, and the reference sign 64 in FIG. 6 represents an intersection of the background plane and the Z axis of the camera coordinate system.

As depicted in FIG. 6, the background plane generating unit 104, for instance, attaches a lattice pattern having equidistant grid lines to the background plane 61 in a color different from a color used for the three-dimension model of the camera mounted object. The background plane generating unit 104 sets on the background plane 61 a background plane coordinate system in which: a coordinate axis extending in the direction of the optic axis of the camera is set as a Z axis; a coordinate axis extending in a horizontal direction of the lattice pattern depicted in FIG. 6 is set as an X axis 62; and a coordinate axis extending in a vertical direction of the lattice pattern depicted in FIG. 6 is set as a Y axis 63.

The three-dimensional model control unit 105 controls data about the three-dimensional model of the camera mounted object, data about the background plane and the data about a model of the camera's view range. The three-dimensional model control unit 105 is, for instance, a storage such as a semiconductor memory device (e.g., random access memory (RAM) and flash memory), and stores the data about the three-dimensional model, the data about the background plane and the data about the model of the camera's view range.

The three-dimensional model display unit 106 outputs and displays the data about the three-dimensional model of the camera mounted object, the data about the background plane and the data about the model of the camera's view range controlled by the three-dimensional model control unit 105 to a display or a monitor.

The camera image generating unit 107 generates a virtual camera image to be captured by the camera, based on the data about the three-dimensional model of the camera mounted object, the data about the background plane and the parameters of the camera to be mounted on the camera mounted object. For instance, the camera image generating unit 107 acquires from the three-dimensional model control unit 105 the data about the three-dimensional model of the camera mounted object and the data about the background plane. The camera image generating unit 107 further acquires the parameters such as the field angles, focal lengths and imaging area sizes of the camera inputted by the camera characteristics data input unit 103. Then, the camera image generating unit 107 generates a virtual camera image with use of a known art such as a projective transformation.

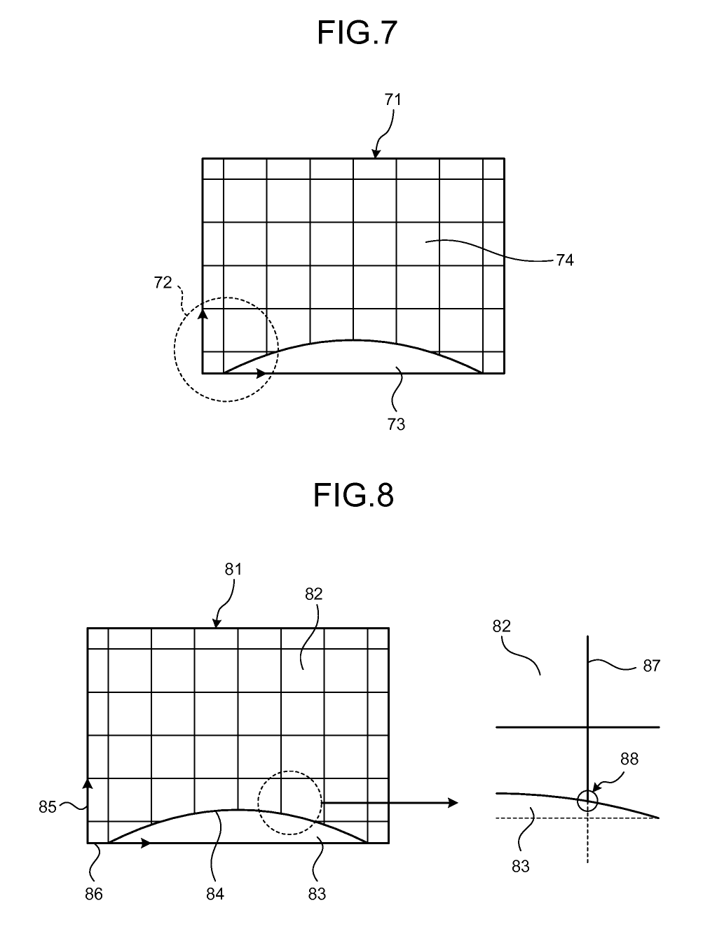

FIG. 7 is a view depicting an example of the camera image according to the second embodiment. FIG. 7 depicts a camera image generated by central projection. The reference sign 71 in FIG. 7 represents the camera image, the reference sign 72 in FIG. 7 represents a camera image coordinate system, the reference sign 73 in FIG. 7 represents the three-dimensional model of the camera mounted object that is caught in the camera image, and the reference sign 74 in FIG. 7 represents the background plane. Note that, in the following description, a region after removing a region in which the three-dimensional model of the camera mounted object is caught from a region corresponding to the background plane 74 within the camera image is referred to as a “view region”. As depicted in FIG. 7, the camera image generating unit 107 completes the generation of the camera image by setting the camera image coordinate system 72 on a computed camera-capturing image. Note that, known arts for generating camera images are, for instance, disclosed in Japanese Laid-open Patent Publication No. 2009-105802.

The camera image display unit 108 outputs and displays the camera image generated by the camera image generating unit 107 to a display or a monitor.

The first view range computing unit 109 computes data for specifying the camera's view range within the virtual background plane, based on the camera image. FIG. 8 is a view to be used for explaining the first view range computing unit 109 according to the second embodiment. The reference sign 81 in FIG. 8 represents the camera image, the reference sign 82 in FIG. 8 represents the background plane within the camera image, the reference sign 83 in FIG. 8 represents the camera mounted object, the reference sign 84 in FIG. 8 represents a boundary of the view region, and the reference signs 85 and 86 in FIG. 8 represent coordinate axes of the camera image coordinate system. Further, the reference sign 87 in FIG. 8 represents the grid line extending in the same direction as the coordinate axis 85 while the reference sign 88 in FIG. 8 represents an intersection of the boundary 84 and the grid line 87.

For instance, the first view range computing unit 109, at first, removes from the background plane 82 within the camera image the region corresponding to the three-dimensional model of the camera mounted object 83, based on the difference between colors set for the background plane and for the camera mounted object. Thereafter, the first view range computing unit 109 extracts edges of the camera image from which the region corresponding to the three-dimensional model of the camera mounted object 83 has been removed, and detects the boundary 84 between the region corresponding to the three-dimensional model of the camera mounted object 83 and the view region. Subsequently, the first view range computing unit 109 detects the intersection 88 of the boundary 84 of the view region and the grid line 87. Likewise, the first view range computing unit 109 detects all intersections of the grid lines set for the background plane and the boundary 84.

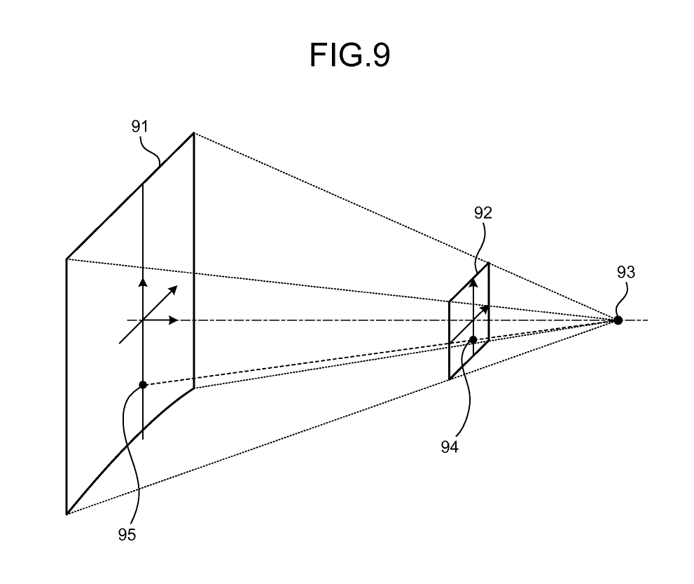

Subsequently, the first view range computing unit 109 detects points on the background plane corresponding to all the intersections detected on the camera image. FIG. 9 is a view to be used for explaining the first view range computing unit 109 according to the second embodiment. The reference sign 91 in FIG. 9 represents the background plane, the reference sign 92 in FIG. 9 represents an imaging area of the camera, the reference sign 93 in FIG. 9 represents the lens center of the camera (i.e., so-called the optical center), the reference sign 94 in FIG. 9 represents a point on the imaging area, and the reference sign 95 in FIG. 9 represents a point on the background plane. Note that, the imaging area 92 depicted in FIG. 9 is an area at which the camera image 81 in FIG. 8 is captured.

For instance, the first view range computing unit 109, at first, converts the positions of the intersections detected on the camera image into three-dimensional positions on the imaging area 92. Then, by projective transformation of the three-dimensional positions of the intersections on the imaging area 92, the first view range computing unit 109 computes positions that are located on the background plane and respectively correspond to the three-dimensional positions on the imaging area 92. For example, by projective transformation of the three-dimensional position of the point 94 on the imaging area 92, the first view range computing unit 109 computes a position of the point 95 on the background plane which corresponds to the point 94. Likewise, the first view range computing unit 109 computes positions that are located on the background plane and respectively correspond to all the intersections detected on the camera image. For instance, data for specifying the camera's view range within the virtual background plane is provided by coordinate values of the positions located on the background plane and respectively corresponding to all the intersections detected on the camera image. In addition, for instance, a smooth curved line that connects the positions located on the background plane and respectively corresponding to all the intersections detected on the camera image, represents a boundary on the camera image between the background plane and the three-dimensional model.

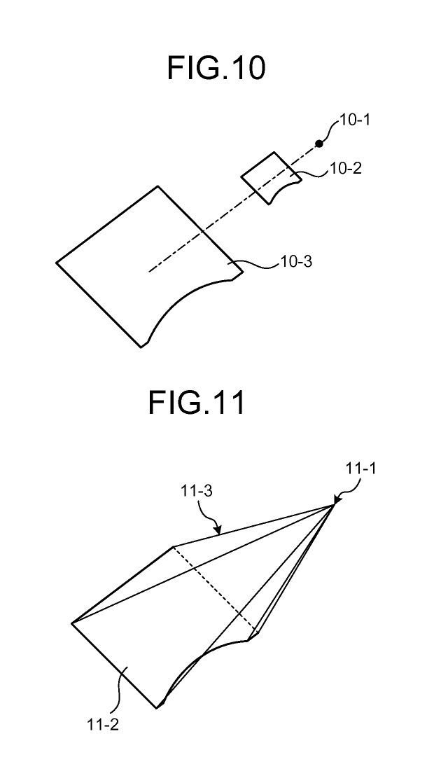

The view model generating unit 110 generates a three-dimensional profile representing the view region, based on the positions located on the background plane and respectively corresponding to all the intersections detected on the camera image. FIGS. 10 and 11 are views to be used for explaining the view model generating unit according to the second embodiment. The reference sign 10-1 in FIG. 10 represents the lens center of the camera, the reference sign 10-2 in FIG. 10 represents a profile of the view region within the imaging area, and the reference sign 10-3 in FIG. 10 represents a profile of the view region within the background plane. The reference sign 11-1 in FIG. 11 represents the lens center of the camera, the reference sign 11-2 in FIG. 11 represents a profile of the view region within the background plane, and the reference sign 11-3 in FIG. 11 represents a three-dimensional profile of the view region.

To begin with, the view model generating unit 110 obtains the profile 10-3 of the view region within the background plane as depicted in FIG. 10, based on: the positions located on the background plane and respectively corresponding to all the intersections detected on the camera image; and positions of each of the vertices of the background plane. For instance, the view model generating unit 110 obtains the profile of the view region within the background plane by connecting together: coordinates that represent three-dimensional positions located on the background plane and respectively corresponding to all the intersections detected on the camera image; and coordinates of three-dimensional positions that represent the positions of each of the vertices of the background plane. As depicted in FIG. 11, the view model generating unit 110 then obtains the three-dimensional profile 11-3 having its vertex at the lens center 11-1 of the camera and having its base plane at the profile 11-2 of the view region within the background plane. This three-dimensional profile 11-3 may also be referred to as a view range model.

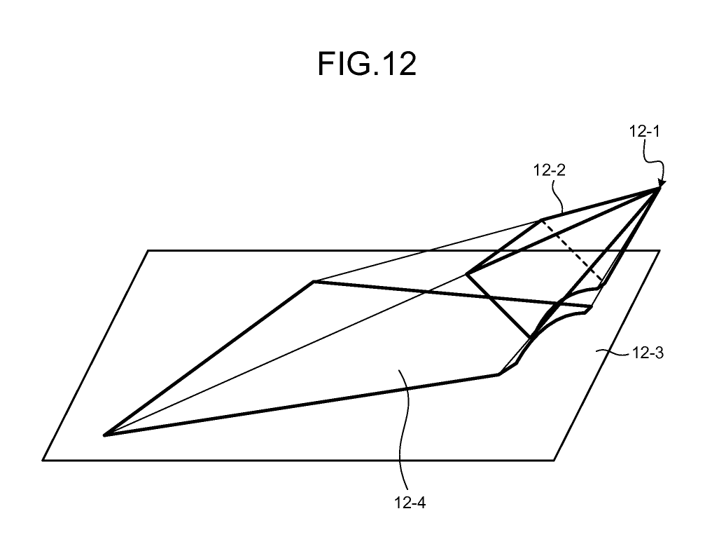

The second view range computing unit 111 computes a profile of a view region within the floor, based on the three-dimensional profile having its vertex at the lens center of the camera and having its base plane at the profile of the view region within the background plane (i.e., the view range model). FIG. 12 is a view to be used for explaining the second view range computing unit according to the second embodiment. The reference sign 12-1 in FIG. 12 represents the lens center of the camera, the reference sign 12-2 in FIG. 12 represents the view range model, the reference sign 12-3 in FIG. 12 represents a plane model of the floor, and the reference sign 12-4 in FIG. 12 represents a profile of a view region within the floor.

At first, the second view range computing unit 111 converts the positions of the view range model belonging to the camera coordinate system, into the positions in the model coordinate system to which the three-dimensional model of the camera mounted object belongs. Further, the second view range computing unit 111 converts the positions of the view range model, into the positions in the world coordinate system to which the plane model of the floor belongs. The second view range computing unit 111 is also capable of converting the positions of the view range model belonging to the camera coordinate system, into the positions in the world coordinate system to which the plane model of the floor belongs, at one time.

Next, the second view range computing unit 111 sets the plane model 12-3 of the floor, based on inputted data about the floor. Subsequently, the second view range computing unit 111 obtains linear segments 12-2 that connect the lens center 12-1 of the camera with each of the vertices of the profile of the view region within the background plane. As depicted in FIG. 12, for instance, the second view range computing unit 111 thereafter obtains the profile 12-4 of the view region within the plane model 12-3 of the floor, based on intersections of: the linear segments that connect the lens center of the camera with each of the vertices of the profile of the view region within the background plane; and the floor.

The camera installation position evaluating system 100 obtains the profile of the view region within the plane model of the floor for each of the plural samples inputted by the camera installation position input unit 102 (i.e., the samples inputted for the installation positions and the orientations of the camera).

The view information output unit 112 outputs the optimum solution for the installation positions and the orientations of the camera, based on an area of the camera's view region projected onto the plane model of the floor. For instance, the view information output unit 112 outputs as the optimum solution the installation position and the orientation taken by the camera when the area of the camera view region projected onto the plane model of the floor is maximized.

Note that, the term “position(s)” in the description of the above-described embodiments refers to a coordinate value(s) in the relevant coordinate system(s).

Processing of Camera Installation Position Evaluating System (Second Embodiment)

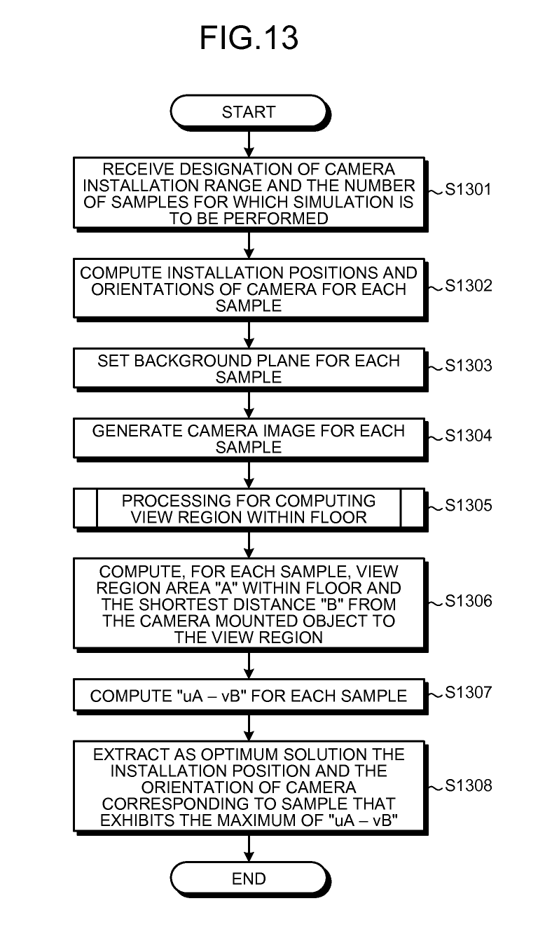

First of all, a processing flow of the camera installation position evaluating system 100 as a whole will be described with reference to FIG. 13. FIG. 13 is a flowchart of a processing of the camera installation position evaluating system according to the second embodiment. FIG. 13 depicts a processing flow through which: the plurality of candidates for the installation positions and the orientations of the camera is inputted; a capturing range of the camera is computed for each inputted candidate; and the optimum solution is extracted based on the result of the computation. The processing by the camera installation position evaluating system 100 according to FIG. 13 is performed for each of the plural samples inputted by the camera installation position input unit 102 as the candidates for the installation positions and the orientations of the camera. Examples of the plural samples are, as described above, coordinate values corresponding to the installation positions of the camera within the camera coordinate system inputted for each camera to be installed, and rotation vector values of the coordinate axes within the camera coordinate system, corresponding to the roll angles and the like of the camera.

As depicted in FIG. 13, when receiving a designation of a camera installation range and the number of the samples for which a simulation is to be performed (step S1301), the camera installation position input unit 102, for instance, computes the installation positions and the orientations of the camera for each of the samples (step S1302).

For instance, it is assumed that the camera installation range is designated as from the minimum value “X1” of the camera's tilting angles to the maximum value “X2” of the camera's tilting angles. Note that, the “tilting angles” are angles that represent how many degrees the optic axis of the camera is inclined downward with respect to the horizontal direction. In addition, it is assumed that the number of the samples for which a simulation is to be performed is designated as “N.” N is a positive integer. The “simulation” means a simulation that computes the camera's capturing range. For instance, the tilting angle of the camera corresponding to the i-th sample is represented by X1+(X2−X1)/Ni.

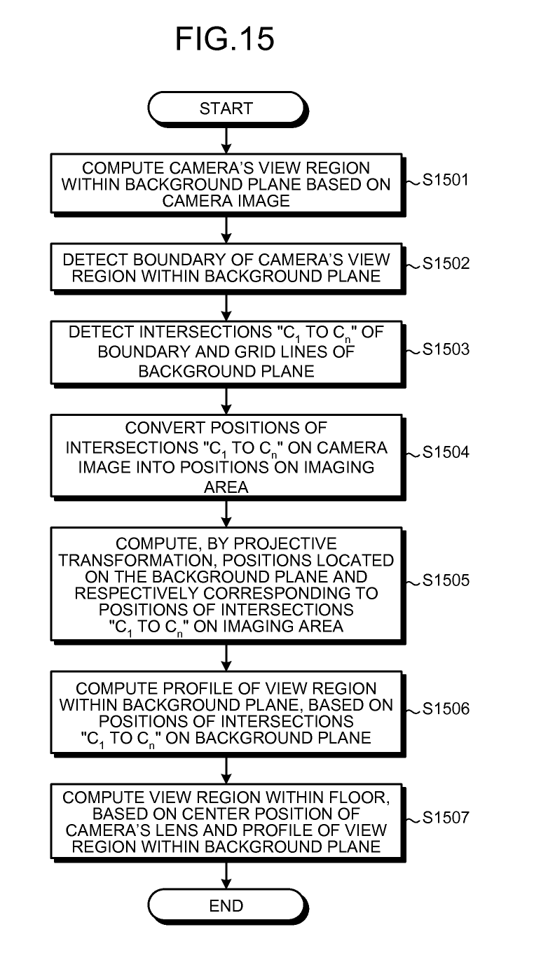

Next, for each sample, the background plane generating unit 104 sets the virtual background plane in the background of the three-dimensional model of the camera mounted object (step S1303). Then, the camera image generating unit 107 generates the camera image for each sample (step S1304). Subsequently, the camera installation position evaluating system 100 performs a processing for computing a view region within the floor (step S1305). The processing for computing the view region within the floor according to step S1305 will be described later with reference to FIG. 15.

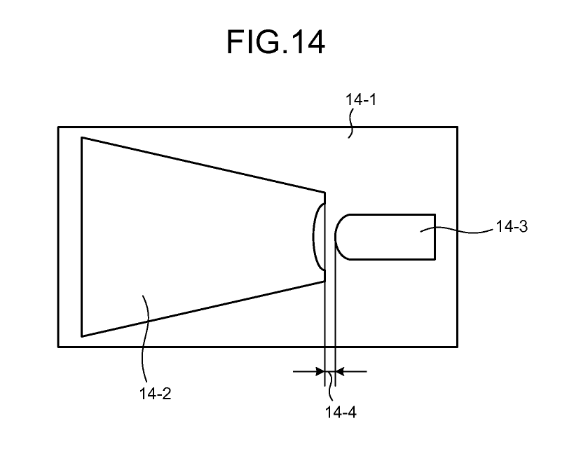

The view information output unit 112 computes a view region area “A” within the floor and the shortest distance “B” from the camera mounted object to the view region within the floor (step S1306). FIG. 14 is a view to be used for explaining the processing by the camera installation position evaluating system according to the second embodiment. The reference sign 14-1 in FIG. 14 represents the floor, the reference sign 14-2 in FIG. 14 represents the view region within the floor, the reference sign 14-3 in FIG. 14 represents the three-dimensional model of the camera mounted object, and the reference sign 14-4 in FIG. 14 represents the shortest distance between the view region within the floor and the three-dimensional model of the camera mounted object. The view region area “A” computed by the view information output unit 112 corresponds to the area of the portion represented by the reference sign 14-2 depicted in FIG. 14, and the shortest distance “B” computed by the view information output unit 112 corresponds to the distance represented by the reference sign 14-4 depicted in FIG. 14.

Further, the view information output unit 112 computes “uA-vB” for each sample (step S1307). Note that, the “u” and “v” are weight coefficients set as needed. The view information output unit 112 then specifies the sample that exhibits the maximum of the “uA-vB,” and extracts as the optimum solution the installation position and the orientation of the camera corresponding to the specified sample (step S1308). Subsequently, the processing is terminated.

Now, a flow of the processing by the camera installation position evaluating system 100 for computing the view region within the floor will be described with reference to FIG. 15. FIG. 15 is a flowchart of a processing of the camera installation position evaluating system according to the second embodiment.

As depicted in FIG. 15, the first view range computing unit 109 computes the camera's view region within the background plane, based on the camera image (step S1501). The first view range computing unit 109 then detects the boundary of the camera's view region within the background plane (step S1502), and detects intersections “C₁ to Cₙ” of the detected boundary and the grid lines of the background plane (step S1503). Note that, the “n” is a positive integer whose value corresponds to the number of the intersections. In other words, when the number of the intersections is ten, the “Cₙ” will be represented as “C₁₀”.

The view model generating unit 110 converts the positions of the intersections “C₁ to Cₙ” on the camera image, into the positions on the imaging area (step S1504). By projective transformation, the view model generating unit 110 then computes positions located on the background plane and respectively corresponding to the positions of the intersections “C₁ to Cₙ” on the imaging area (step S1505).

The second view range computing unit 111 computes a profile of the view range within the background plane, based on the positions of the intersections “C₁ to Cₙ” on the background plane (step S1506). The second view range computing unit 111 then computes the profile of the view region within the floor, based on the center position of the camera's lens and the profile of the view region within the background plane (step S1507), and terminates the processing for computing the view region within the floor.

### Effect of Second Embodiment

As described above, the camera installation position evaluating system 100 sets, in the optic axis of the camera mounted on the camera mounted object, the virtual plane orthogonal to the optic axis, and subsequently generates the virtual camera image to be captured by the camera on the assumption that photographing is conducted with the camera. The camera installation position evaluating system 100 then computes the boundary between the three-dimensional model of the camera mounted object and the virtual plane set by the setting unit 2. Thus, the camera installation position evaluating system 100 is able to quantitatively obtain the camera's view range at the present camera installation position based on the computed boundary. Accordingly, a trial and error by a designer in determining the installation position of the camera is dispensable, and the camera installation position evaluating system 100 is capable of efficiently and more accurately determining, for instance, the installation position of the camera at which the camera's view range is maximized.

According to the second embodiment, the view region of the camera within the floor on which the camera mounted object is located is computed with use of the three-dimensional model representing the camera's view range. Therefore, a designer is able to obtain the view region corresponding to an image actually captured by the camera.

Further, according to the second embodiment, the background plane is set in a color different from that of the three-dimensional model of the camera mounted object. Thus, the camera's view region is efficiently computable based on the generated virtual camera image.

### [c] Third Embodiment

Another embodiment of the camera installation position evaluating system according to the present invention will be described below.

(1) Configuration of System

For instance, the components of the camera installation position evaluating system 100 depicted in FIG. 2 are merely for explaining functional concepts, and thus the camera installation position evaluating system 100 does not have to be physically configured in the same configuration as depicted therein. In other words, an actual form of the distribution or integration of the camera installation position evaluating system 100 is not limited to those depicted. For example, the first view range computing unit 109 and the second view range computing unit 111 may be functionally or physically integrated. In this way, all or part of the camera installation position evaluating system 100 may be functionally or physically distributed or integrated on the basis of any desirable unit, in accordance with a variety of loads, usages and the like.

(2) Camera Installation Position Evaluating Method

According to the above-described second embodiment, a camera installation position evaluating method that includes the following steps is realized. Specifically, this camera installation position evaluating method includes a setting step that sets a virtual background plane orthogonal to the optic axis of the camera to be mounted on the camera mounted object. This setting step corresponds to the processing performed by the background plane generating unit 104 in FIG. 2. Further, the camera installation position evaluating method also includes a generating step that generates a virtual camera image to be captured by the camera, based on data about the three-dimensional model of the camera mounted object, data about the virtual background plane set by the setting step and parameters of the camera. This generating step corresponds to the processing performed by the camera image generating unit 107 in FIG. 2. The camera installation position evaluating method further includes a computing step that computes a boundary between the three-dimensional model of the camera mounted object and the virtual background plane, on the camera image generated by the generating step. This computing step corresponds to the processing performed by the first view range computing unit 109 in FIG. 2.

(3) Camera Installation Position Evaluating Program

Further, for instance, the various processing performed by the camera installation position evaluating system 100 described in the second embodiment may be realized by running a preliminarily-prepared program in a computer system such as a personal computer or a workstation. For the various processing performed by the camera installation position evaluating system 100, a reference may be made, for example, to FIG. 13.

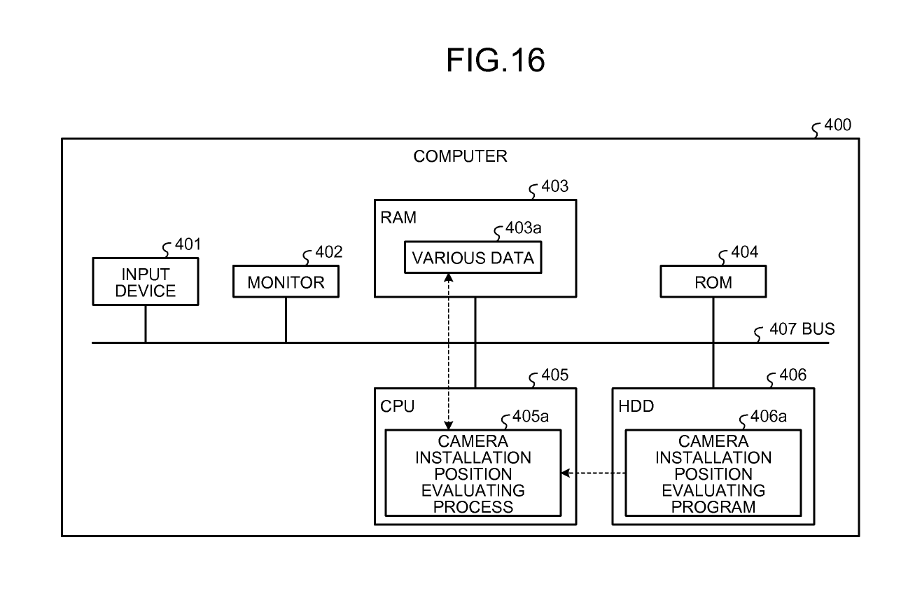

Accordingly, with reference to FIG. 16, a description will be made below of an example of a computer that runs a camera installation position evaluating program that realizes functions similar to those provided through the processing by the camera installation position evaluating system 100 described in the second embodiment. FIG. 16 is a view that depicts an example of the computer that runs the camera installation position evaluating program.

As depicted in FIG. 16, a computer 400 serving as the camera installation position evaluating system 100 includes an input device 401, a monitor 402, a random access memory (RAM) 403 and a read only memory (ROM) 404. The computer 400 also includes a central processing unit (CPU) 405 and a hard disk drive (HDD) 406.

Note that, examples of the input device 401 are a keyboard and a mouse. The monitor 402 exerts a pointing device function in cooperation with a mouse (i.e., the input device 401). The monitor 402, which is a display device for displaying information such as images of the three-dimensional model, may alternatively be a display or a touch panel. Note that, the monitor 402 does not necessarily exert a pointing device function in cooperation with a mouse serving as the input device, but may exert a pointing device function with use of another input device such as touch panel.

Note that, in place of the CPU 405, an electronic circuit such as a micro processing unit (MPU) or an integrated circuit such as an application specific integrated circuit (ASIC) or a field programmable gate array (FPGA) may be used. Further, in place of the RAM 403 or the ROM 404, a semiconductor memory device such as a flash memory may be used.

In the computer 400, the input device 401, the monitor 402, the RAM 403, the ROM 404, the CPU 405 and the HDD 406 are connected to one another by a bus 407.

The HDD 406 stores a camera installation position evaluating program 406a that functions similarly to the above-described camera installation position evaluating system 100.

The CPU 405 reads out the camera installation position evaluating program 406a from the HDD 406 and deploys the camera installation position evaluating program 406a in the RAM 403. As depicted in FIG. 16, the camera installation position evaluating program 406a then functions as a camera installation position evaluating process 405a.

In other words, the camera installation position evaluating process 405a deploys various data 403a in areas of the RAM 403 assigned respectively to the data, and performs various processing based on the deployed various data 403a.

Note that, the camera installation position evaluating process 405a includes, for instance, a processing corresponding to the processing performed by the background plane generating unit 104 depicted in FIG. 2. Further, the camera installation position evaluating process 405a includes, for instance, a processing corresponding to the processing performed by the camera image generating unit 107 depicted in FIG. 2. The camera installation position evaluating process 405a includes, for instance, a processing corresponding to the processing performed by the camera image display unit 108 depicted in FIG. 2. The camera installation position evaluating process 405a includes, for instance, a processing corresponding to the processing performed by the first view range computing unit 109 depicted in FIG. 2. The camera installation position evaluating process 405a includes, for instance, a processing corresponding to the processing performed by the view model generating unit 110 depicted in FIG. 2. The camera installation position evaluating process 405a includes, for instance, a processing corresponding to the processing performed by the second view range computing unit 111 depicted in FIG. 2. The camera installation position evaluating process 405a includes, for instance, a processing corresponding to the processing performed by the view information output unit 112 depicted in FIG. 2.

Note that, the camera installation position evaluating program 406a is not necessarily preliminarily stored in the HDD 406. For instance, each program may be stored in a “portable physical medium” to be inserted into the computer 400, such as a flexible disk (FD), a CD-ROM, a DVD disk, a magnetic optical disk and an IC card. Then, the computer 400 may read out each program from the portable physical medium to run the program.

According to an aspect of the invention disclosed herein, in determining the installation position of the camera, a trial and error by a designer is dispensable, and the installation position of the camera can be determined efficiently and accurately.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable recording medium having stored therein a program for causing a computer to execute a process for evaluating a camera installation position, the process comprising:
setting a virtual plane orthogonal to an optic axis of a camera mounted on a camera mounted object;
generating virtually a camera image to be captured by the camera, based on data about a three-dimensional model of the camera mounted object, data about the virtual plane that has been set and parameters of the camera; and
computing a boundary between an area of the three-dimensional model and an area of the virtual plane, on the camera image that has been generated.

2. The computer-readable recording medium according to claim 1, wherein the process further comprises:
first computing a view region of the camera within the virtual plane set by the setting, based on the boundary that has been computed;
generating a view volume model, the view volume model having a vertex at a lens center of the camera and having a base plane at the view region within the virtual plane, the view region having been first computed; and
second computing a view region of the camera within a floor on which the three-dimensional model is located, based on the view volume model that has been generated.

3. The computer-readable recording medium according to claim 2, wherein a color that is different from a color used for the three-dimensional model is set for the virtual plane.

4. A camera installation position evaluating method performed by a camera installation position evaluating system that evaluates an installation position of a camera, the method comprising:
setting a virtual plane orthogonal to an optic axis of the camera mounted on a camera mounted object;
generating virtually, using a processor, a camera image to be captured by the camera, based on data about a three-dimensional model of the camera mounted object, data about the virtual plane set by the setting and parameters of the camera; and
computing a boundary between an area of the three-dimensional model and an area of the virtual plane, on the camera image generated by the generating.

5. A camera installation position evaluating system including a processor, the processor executing a process comprising:
setting a virtual plane orthogonal to an optic axis of a camera to be mounted on a camera mounted object;
generating virtually a camera image to be captured by the camera, based on data about a three-dimensional model of the camera mounted object, data about the virtual plane set by the setting and parameters of the camera; and
computing a boundary between an area of the three-dimensional model and an area of the virtual plane, on the camera image generated by the generating.
